(19) United States
(12) Patent Application Publication
(10) Pub. No.: US 2026/0013673 A1
(43) Pub. Date: Jan. 15, 2026

(54) FRUIT AND VEGETABLE WASHING DEVICE

(71) Applicant: Anson Bellard, Texas City, TX (US)

(72) Inventor: Anson Bellard, Texas City, TX (US)

(21) Appl. No.: 18/770,069

(22) Filed: Jul. 11, 2024

(51) Int. Cl. A47J 43/24

(52) U.S. Cl. CPC A47J 43/24

(57) ABSTRACT

A fruit and vegetable washing device includes a cup comprised of a fluid impermeable material to contain fruits or vegetables and water for rinsing the fruits or vegetables. A pair of viewing windows is each is integrated into the cup to enable the fruits or vegetables to be visible in the cup. A screen is removably positionable into the cup to enable the water to be drained from the cup while retaining the fruits or vegetables within the cup. A lid is removably attachable to the cup to inhibit the water and the fruits or vegetables from passing through the lid. A drain spout is integrated into the lid to enable the water to be drained through the drain spout when the cup is inverted. A cap is movably attached to the drain spout for opening or closing the drain spout.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to washing devices and more particularly pertains to a new washing device for rinsing, draining and storing fruits and vegetables for subsequent consumption. The device includes a cup for storing fruits and/or vegetables which has a pair of viewing windows to enable the fruits and/or vegetables to be visible in the cup. The device includes a screen that is positionable on the cup and a lid that that is removably attachable to the cup for retaining the fruits and/or vegetables in the cup. The lid has a drain spout for draining water that is poured into the cup for rinsing the fruits and/or vegetables. The drain spout has a cap that is hingedly attached to the drain spout to enable to water to be retained in the cup for rinsing the fruits and/or vegetables and which can be opened to enable the water to be drained from the cup.

### (2) Description of Related Art Including Information Disclosed Under 37 CFR 1.97 and 1.98

The prior art relates to washing devices including a fruit cleaning device that includes a bowl that has a series of blades and scrapers for scrubbing fruit that is placed in the bowl and a lid that is attachable to the bowl which has a spout for draining water from the bowl and a food washing and drying device that includes a bulb for containing food items and water for rinsing the food items and a perforated lid that is attachable to the bulb for draining the water and a fruit or vegetable washing device that includes a container for containing fruits or vegetables and water for rinsing the fruits or vegetables and a valve attached to the container that can facilitate the water to be drained from the container while retaining the fruits or vegetables in the container and a vegetable and fruit washing device that includes a cup for containing fruits or vegetables and water for rinsing the fruits or vegetables and a dual lid that comprises a first lid comprising a foraminous disk for draining the water and a second lid comprising a disk with a hole for draining the water through the hole. In no instance does the prior art disclose a fruit or vegetable rinsing device that includes a cup for containing fruits and/or vegetables and water for rinsing the fruits and/or vegetables and a screen that is positionable on the cup and a lid that is removably attachable to the cup which has a drain spout for draining the water from the cup while retaining the fruits and/or vegetables in the cup.

### BRIEF SUMMARY OF THE INVENTION

An embodiment of the disclosure meets the needs presented above by generally comprising a cup comprised of a fluid impermeable material to contain fruits or vegetables and water for rinsing the fruits or vegetables. A pair of viewing windows is each is integrated into the cup to enable the fruits or vegetables to be visible in the cup. A screen is removably positionable into the cup to enable the water to be drained from the cup while retaining the fruits or vegetables within the cup. A lid is removably attachable to the cup to inhibit the water and the fruits or vegetables from passing through the lid. A drain spout is integrated into the lid to enable the water to be drained through the drain spout when the cup is inverted. A cap is movably attached to the drain spout for opening or closing the drain spout.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded perspective view of a fruit and vegetable washing device according to an embodiment of the disclosure.

FIG. 2 is a top perspective view of an embodiment of the disclosure.

FIG. 3 is a bottom perspective exploded view of an embodiment of the disclosure.

FIG. 4 is a left side view of an embodiment of the disclosure.

FIG. 5 is a cross sectional view taken along line 5-5 of FIG. 4 of an embodiment of the disclosure.

FIG. 6 is a top view of a cup of an embodiment of the disclosure.

FIG. 7 is a perspective in-use view of an embodiment of the disclosure showing water being poured into a cup for rinsing fruits and/or vegetables contained in the cup.

FIG. 8 is a perspective in-use view of an embodiment of the disclosure showing water being drained from a cup.

### DETAILED DESCRIPTION OF THE INVENTION

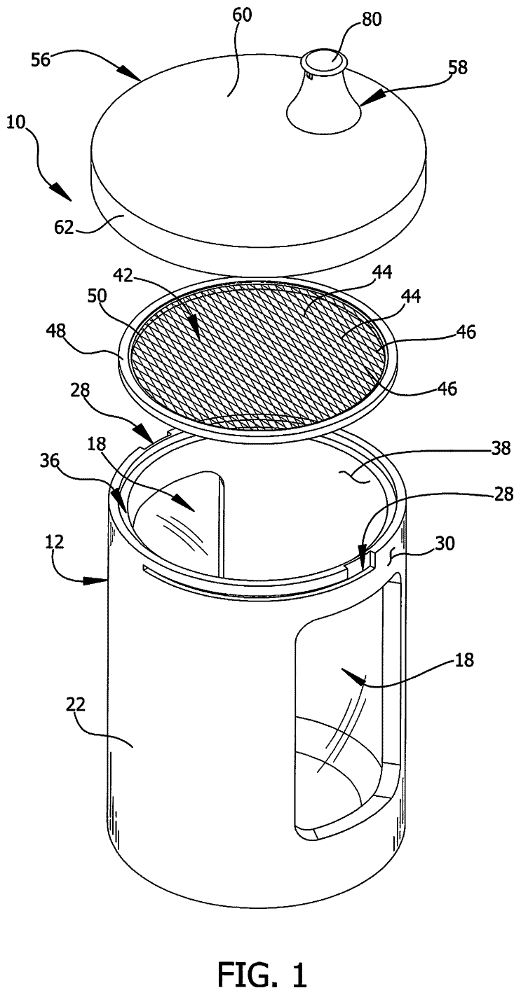

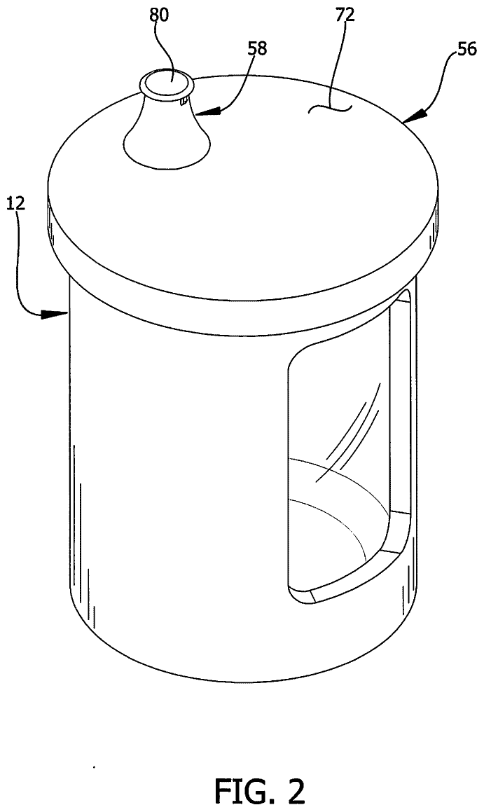

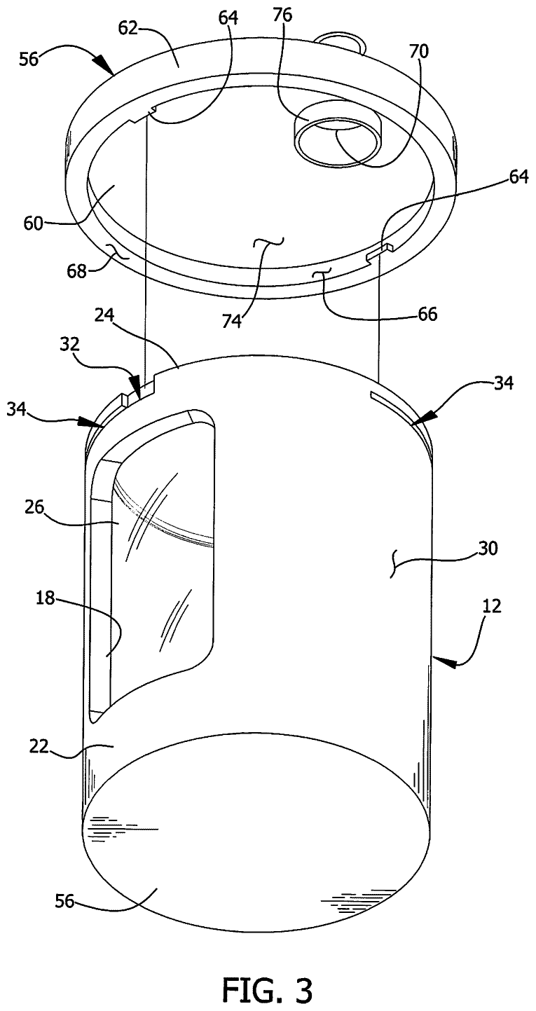

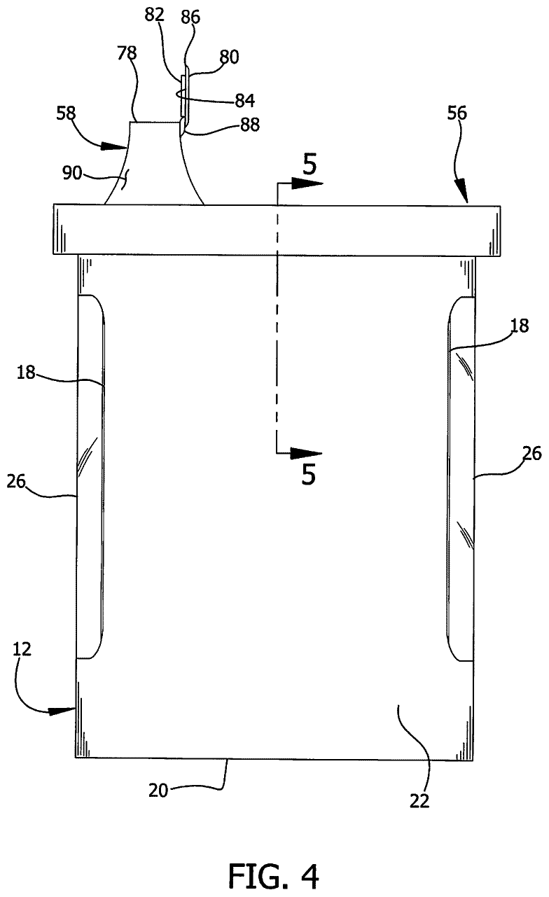

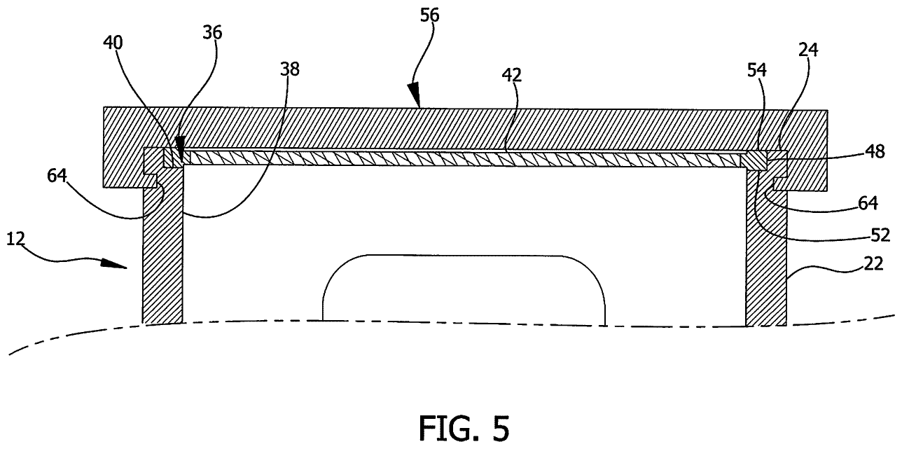

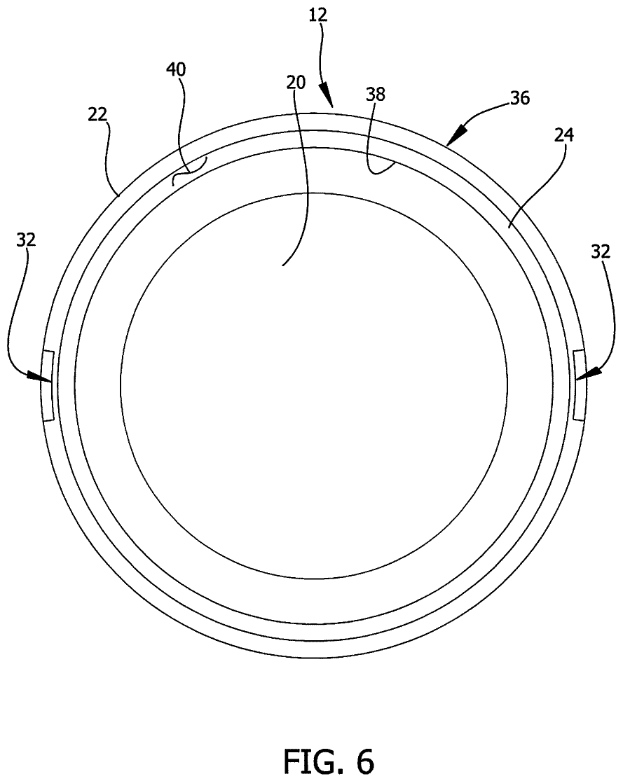

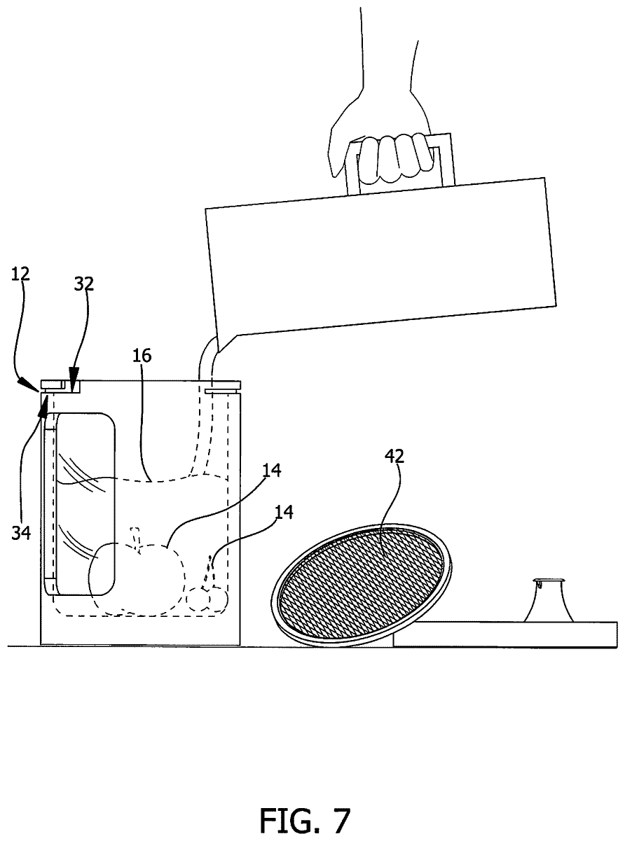

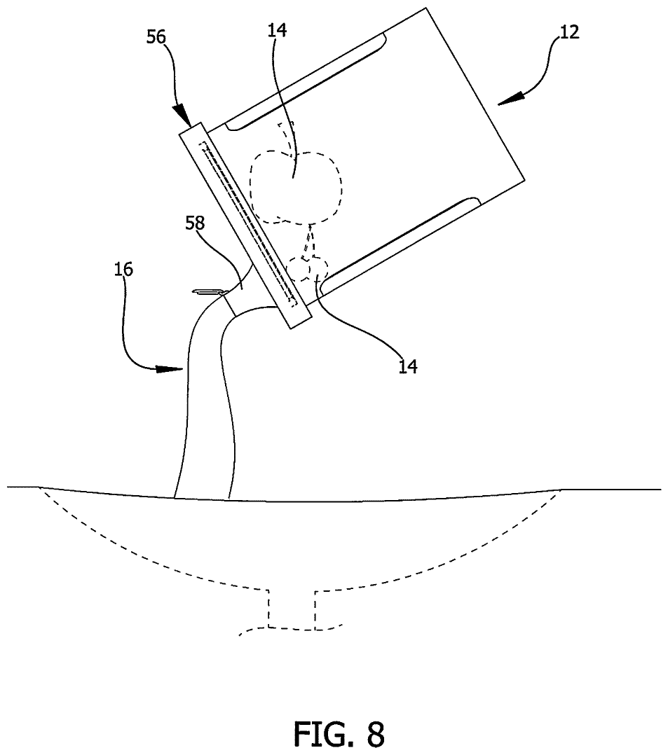

With reference now to the drawings, and in particular to FIGS. 1 through 8 thereof, a new washing device embodying the principles and concepts of an embodiment of the disclosure and generally designated by the reference numeral 10 will be described.

As best illustrated in FIGS. 1 through 8, the fruit and vegetable washing device 10 generally comprises a cup 12 that is comprised of a fluid impermeable material, including but not being limited to plastic or metal, thereby enabling the cup 12 to contain fruits or vegetables 14 and water 16 for rinsing the fruits or vegetables 14. The cup 12 has a pair of viewing windows 18 each integrated into the cup 12 to enable the fruits or vegetables 14 to be visible in the cup 12. The cup 12 has a basal wall 20 and a perimeter wall 22 extending upwardly from the basal wall 20 and each of the pair of viewing windows 18 extends through the perimeter wall 22. Each of the pair of viewing windows 18 is elongated along a vertical axis such that each of the pair of viewing windows 18 extends substantially between the basal wall 20 and a top edge 24 of the perimeter wall 22. Additionally, each of the pair of viewing windows 18 is positioned on opposite sides of the perimeter wall 22 with respect to each other. The cup 12 includes a pair of lenses 26 each positioned within a respective one of the pair of viewing windows 18 having each of the pair of lenses 26 completely covering the respective viewing window 18. Each of the pair of lenses 26 is comprised of a translucent material, including but not being limited to plastic or glass, thereby enabling each of the pair of lenses 26 to pass light into the cup 12 such that the fruits or vegetables 14 are visible in the cup 12.

The cup 12 has a pair of slots 28 each recessed into an exterior surface 30 of the perimeter wall 22 of the cup 12 and each of the pair of slots 28 includes a vertical portion 32 extending downwardly from the top edge 24 of the perimeter wall 22. Additionally, each of the pair of slots 28 has a horizontal portion 34 which is perpendicularly oriented with the vertical portion 32 such that the horizontal portion 34 of each of the pair of slots 28 is spaced downwardly from and extends along a line that is oriented parallel to the top edge 24 of the perimeter wall 22. Furthermore, each of the pair of slots 28 is positioned on opposite sides of the perimeter wall 22 with respect to each other. The perimeter wall 22 has a groove 36 which is recessed into the top edge 24 of the perimeter wall 22 and the groove 36 is continuous such that the groove 36 extends around a full circumference of the top edge 24. Additionally, the groove 36 is aligned with an interior surface 38 of the perimeter wall 22 and the groove 36 has a lower bounding surface 40.

A screen 42 is removably positionable into the cup 12 such that the screen 42 closes the cup 12. The screen 42 is comprised of a fluid permeable material, which is defined by a series of intersecting members 44 that are evenly spaced apart to define a plurality of holes 46 in the screen 42, to enable the water 16 to be drained from the cup 12 while retaining the fruits or vegetables 14 within the cup 12. The screen 42 includes an annular ring 48 which extends around a perimeter edge 50 of the screen 42. A bottom surface 52 of the annular ring 48 rests upon the lower bounding surface 40 of the groove 36 in the top edge 24 of the perimeter wall 22 of the cup 12 when the screen 42 is positioned in the cup 12 having a top surface 54 of the annular ring 48 being aligned with the top edge 24 of the perimeter wall 22 of the cup 12.

A lid 56 is removably attachable to the cup 12 and the lid 56 is comprised of a fluid impermeable material, including but not being limited to plastic or metal, to inhibit the water 16 and the fruits or vegetables 14 from passing through the lid 56. The lid 56 has a drain spout 58 that is integrated into the lid 56 and the drain spout 58 is open to enable the water 16 to be drained through the drain spout 58 when the cup 12 is inverted. The lid 56 has an upper wall 60 and a perimeter wall 62 extending downwardly from the upper wall 60 and the lid 56 has a pair of tabs 64 each extending inwardly from an inwardly facing surface 66 of the perimeter wall 62 of the lid 56. Each of the pair of tabs 64 is aligned with a lower surface 68 of the perimeter wall 62 of the lid 56 and each of the pair of tabs 64 is positioned on opposite sides of the perimeter wall 62 of the lid 56 with respect to each other. Each of the pair of tabs 64 extends into the vertical portion 32 of a respective one of the pair of slots 28 in the perimeter wall 22 of the cup 12 when the lid 56 is positioned on the cup 12. Furthermore, the lid 56 is rotatable into a locked position having each of the pair of tabs 64 traveling along the horizontal portion 34 of the respective slot 28 thereby retaining the lid 56 on the cup 12.

The lid 56 has a hole 70 extending through a topmost surface 72 and a lowermost surface 74 of the upper wall 60 to enable the water 16 to pass through the hole 70. The lid 56 has a ring 76 extending downwardly from the lowermost surface 74 of the upper wall 60 and the ring 76 surrounds the hole 70. The drain spout 58 extends upwardly from the topmost surface 72 of the upper wall 60 having the drain spout 58 surrounding the hole 70. The drain spout 58 tapers between the topmost surface 72 and a distal end 78 of the drain spout 58 such that the distal end 78 has a diameter is less than a diameter of the hole 70. The distal end 78 is open to enable the water 16 to pass through the distal end 78.

A cap 80 is movably attached to the drain spout 58 for opening or closing the drain spout 58. The cap 80 has a ring 82 extending downwardly from a bottom surface 84 of the cap 80 and the ring 82 is spaced inwardly from an outer edge 86 of the cap 80. Additionally, the ring 82 is positioned in the distal end 78 of the drain spout 58 when the cap 80 is in a closed position having the cap 80 resting upon the distal end 78 of the drain spout 58. In this way the cap 80 inhibits the water 16 from flowing through the drain spout 58 thereby enabling the cup 12 to be shaken for rinsing the fruits or vegetables 14 in the water 16 in the cup 12. A hinge 88 is coupled between the outer edge 86 of the cap 80 and an outer surface 90 of the drain spout 58 thereby hingedly retaining the cap 80 on the drain spout 58. In this way the cap 80 is enabled to be positioned between the closed position and an open position to enable the water 16 to flow through the drain spout 58 when the cap 80 is in the open position.

In use, the fruits or vegetables 14 are placed into the cup 12 and a desired volume of water 16 is poured into the cup 12. The screen 42 is positioned in the groove 36 and the lid 56 is attached to the cup 12 and the cap 80 is placed into the closed position. The cup 12 is shaken or otherwise agitated to enable the fruits or vegetables 14 to be rinsed in the cup 12 thereby cleaning the fruits or vegetables 14. The cap 80 is placed into the open position and the cup 12 is inverted to enable the water 16 to be poured through the drain spout 58. The lid 56 and the screen 42 are each removed from the cup 12 to enable the fruits or vegetables 14 to be removed from the cup 12 to eat the fruits or vegetables 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fruit and vegetable washing device for washing and subsequently draining fruits or vegetables prior to consumption of the fruits or vegetables, said device comprising:
a cup being comprised of a fluid impermeable material wherein said cup is configured to contain fruits or vegetables and water for rinsing the fruits or vegetables, said cup having a pair of viewing windows each being integrated into said cup wherein said pair of viewing windows is configured to enable the fruits or vegetables to be visible in said cup;
a screen being removably positionable into said cup such that said screen closes said cup, said screen being comprised of a fluid permeable material wherein said screen is configured to enable the water to be drained from said cup while retaining the fruits or vegetables within said cup;
a lid being removably attachable to said cup, said lid being comprised of a fluid impermeable material wherein said lid is configured to inhibit the water and the fruits or vegetables from passing through said lid, said lid having a drain spout being integrated into said lid, said drain spout being open wherein said drain spout is configured to enable the water to be drained through said drain spout when said cup is inverted; and
a cap being movably attached to said drain spout for opening or closing said drain spout.

2. The device according to claim 1, wherein:
said cup has a basal wall and a perimeter wall extending upwardly from said basal wall;
each of said pair of viewing windows extends through said perimeter wall;
each of said pair of viewing windows is elongated along a vertical axis such that each of said pair of viewing windows extends substantially between said basal wall and a top edge of said perimeter wall;
each of said pair of viewing windows is positioned on opposite sides of said perimeter wall with respect to each other;
said cup includes a pair of lenses each being positioned within a respective one of said pair of viewing windows having each of said pair of lenses completely covering said respective viewing window;
each of said pair of lenses is comprised of a translucent material wherein each of said pair of lenses is configured to pass light into said cup thereby enabling the fruits or vegetables to be visible in said cup;
said cup has a pair of slots each being recessed into an exterior surface of said perimeter wall of said cup;
each of said pair of slots includes a vertical portion extending downwardly from said top edge of said perimeter wall;
each of said pair of slots has a horizontal portion being perpendicularly oriented with said vertical portion such that said horizontal portion of each of said pair of slots is spaced downwardly from and extends along a line being oriented parallel to said top edge of said perimeter wall;
each of said pair of slots is positioned on opposite sides of said perimeter wall with respect to each other;
said perimeter wall has a groove being recessed into said top edge of said perimeter wall;
said groove is continuous such that said groove extends around a full circumference of said top edge; and
said groove is aligned with an interior surface of said perimeter wall, said groove having a lower bounding surface.

3. The device according to claim 1, wherein:
said cup has a perimeter wall which has a top edge;
said perimeter wall has a groove being recessed into said top edge of said perimeter wall;
said groove is continuous such that said groove extends around a full circumference of said top edge;
said groove is aligned with an interior surface of said perimeter wall, said groove having a lower bounding surface;
said screen includes an annular ring extending around a perimeter edge of said screen; and
a bottom surface of said annular ring rests upon said lower bounding surface of said groove in said top edge of said perimeter wall of said cup when said screen is positioned in said cup having a top surface of said annular ring being aligned with said top edge of said perimeter wall of said cup.

4. The device according to claim 2, wherein:
said lid has an upper wall and a perimeter wall extending downwardly from said upper wall;
said lid has a pair of tabs each extending inwardly from an inwardly facing surface of said perimeter wall of said lid;
each of said pair of tabs is aligned with a lower surface of said perimeter wall of said lid;
each of said pair of tabs is positioned on opposite sides of said perimeter wall of said lid with respect to each other;
each of said pair of tabs extends into said vertical portion of a respective one of said pair of slots in said perimeter wall of said cup when said lid is positioned on said cup; and
said lid is rotatable into a locked position having each of said pair of tabs traveling along said horizontal portion of said respective slot thereby retaining said lid on said cup.

5. The device according to claim 1, wherein:
said lid has a hole extending through a topmost surface and a lowermost surface of an upper wall wherein said hole is configured to enable the water to pass through said hole;
said lid has a ring extending downwardly from said lowermost surface of said upper wall;
said ring surrounding said hole;
said drain spout extends upwardly from said topmost surface of said upper wall having said drain spout surrounding said hole;
said drain spout tapers between said topmost surface and a distal end of said drain spout such that said distal end has a diameter being less than a diameter of said hole; and
said distal end is open wherein said distal end is configured to enable the water to pass through said distal end.

6. The device according to claim 5, wherein:
said cap has a ring extending downwardly from a bottom surface of said cap;
said ring is spaced inwardly from an outer edge of said cap;
said ring is positioned in said distal end of said drain spout when said cap is in a closed position having said cap resting upon said distal end of said drain spout wherein said cap is configured to inhibit the water from flowing through said drain spout thereby enabling said cup to be shaken for rinsing the fruits or vegetables in the water in said cup;
said cap has a hinge being coupled between said outer edge of said cap and an outer surface of said drain spout thereby hingedly retaining said cap on said drain spout to enable said cap to be positioned between said closed position and an open position wherein said cap is configured to enable the water to flow through said drain spout when said cap is in said open position.

7. A fruit and vegetable washing device for washing and subsequently draining fruits or vegetables prior to consumption of the fruits or vegetables, said device comprising:
a cup being comprised of a fluid impermeable material wherein said cup is configured to contain fruits or vegetables and water for rinsing the fruits or vegetables, said cup having a pair of viewing windows each being integrated into said cup wherein said pair of viewing windows is configured to enable the fruits or vegetables to be visible in said cup, said cup having a basal wall and a perimeter wall extending upwardly from said basal wall, each of said pair of viewing windows extending through said perimeter wall, each of said pair of viewing windows being elongated along a vertical axis such that each of said pair of viewing windows extends substantially between said basal wall and a top edge of said perimeter wall, each of said pair of viewing windows being positioned on opposite sides of said perimeter wall with respect to each other, said cup including a pair of lenses each being positioned within a respective one of said pair of viewing windows having each of said pair of lenses completely covering said respective viewing window, each of said pair of lenses being comprised of a translucent material wherein each of said pair of lenses is configured to pass light into said cup thereby enabling the fruits or vegetables to be visible in said cup, said cup having a pair of slots each being recessed into an exterior surface of said perimeter wall of said cup, each of said pair of slots including a vertical portion extending downwardly from said top edge of said perimeter wall, each of said pair of slots having a horizontal portion being perpendicularly oriented with said vertical portion such that said horizontal portion of each of said pair of slots is spaced downwardly from and extends along a line being oriented parallel to said top edge of said perimeter wall, each of said pair of slots being positioned on opposite sides of said perimeter wall with respect to each other, said perimeter wall having a groove being recessed into said top edge of said perimeter wall, said groove being continuous such that said groove extends around a full circumference of said top edge, said groove being aligned with an interior surface of said perimeter wall, said groove having a lower bounding surface;
a screen being removably positionable into said cup such that said screen closes said cup, said screen being comprised of a fluid permeable material wherein said screen is configured to enable the water to be drained from said cup while retaining the fruits or vegetables within said cup, said screen including an annular ring extending around a perimeter edge of said screen, a bottom surface of said annular ring resting upon said lower bounding surface of said groove in said top edge of said perimeter wall of said cup when said screen is positioned in said cup having a top surface of said annular ring being aligned with said top edge of said perimeter wall of said cup;
a lid being removably attachable to said cup, said lid being comprised of a fluid impermeable material wherein said lid is configured to inhibit the water and the fruits or vegetables from passing through said lid, said lid having a drain spout being integrated into said lid, said drain spout being open wherein said drain spout is configured to enable the water to be drained through said drain spout when said cup is inverted, said lid having an upper wall and a perimeter wall extending downwardly from said upper wall, said lid having a pair of tabs each extending inwardly from an inwardly facing surface of said perimeter wall of said lid, each of said pair of tabs being aligned with a lower surface of said perimeter wall of said lid, each of said pair of tabs being positioned on opposite sides of said perimeter wall of said lid with respect to each other, each of said pair of tabs extending into said vertical portion of a respective one of said pair of slots in said perimeter wall of said cup when said lid is positioned on said cup, said lid being rotatable into a locked position having each of said pair of tabs traveling along said horizontal portion of said respective slot thereby retaining said lid on said cup, said lid having a hole extending through a topmost surface and a lowermost surface of said upper wall wherein said hole is configured to enable the water to pass through said hole, said lid having a ring extending downwardly from said lowermost surface of said upper wall, said ring surrounding said hole, said drain spout extending upwardly from said topmost surface of said upper wall having said drain spout surrounding said hole, said drain spout tapering between said topmost surface and a distal end of said drain spout such that said distal end has a diameter being less than a diameter of said hole, said distal end being open wherein said distal end is configured to enable the water to pass through said distal end; and
a cap being movably attached to said drain spout for opening or closing said drain spout, said cap having a ring extending downwardly from a bottom surface of said cap, said ring being spaced inwardly from an outer edge of said cap, said ring being positioned in said distal end of said drain spout when said cap is in a closed position having said cap resting upon said distal end of said drain spout wherein said cap is configured to inhibit the water from flowing through said drain spout thereby enabling said cup to be shaken for rinsing the fruits or vegetables in the water in said cup, said cap having a hinge being coupled between said outer edge of said cap and an outer surface of said drain spout thereby hingedly retaining said cap on said drain spout to enable said cap to be positioned between said closed position and an open position wherein said cap is configured to enable the water to flow through said drain spout when said cap is in said open position.
